(19) United States
(12) Patent Application Publication
(10) Pub. No.: US 2024/0335765 A1
(43) Pub. Date: Oct. 10, 2024

(54) SOLVENT CHANNEL IDENTIFICATION

(71) Applicant: Agilent Technologies, Inc., Santa Clara, CA (US)

(72) Inventors: Bettina Schuhn, Karlsruhe (DE); Johnny Ebsen, Pfinztal (DE); Thomas Romanowski, Karlsruhe (DE)

(21) Appl. No.: 18/681,671

(22) PCT Filed: Aug. 5, 2022
(86) PCT No.: PCT/IB2022/057302

§ 371 Date: Feb. 6, 2024

(30) Foreign Application Priority Data
Aug. 6, 2021 (GB) 2111355.0

(51) Int. Cl. B01D 15/20; B01D 15/18

(52) U.S. Cl. CPC B01D 15/20; B01D 15/18

(57) ABSTRACT

A solvent supply system supplies solvent for one or more chromatographic separation systems each including one or more input channels. Each input channel is configured for fluidically coupling with a respective solvent container for supplying the respective input channel with a respective solvent from the respective solvent container. The solvent supply system includes a solvent identification unit configured for providing a channel identification for identifying a specific solvent container to supply a specific input channel of a specific chromatographic separation system, and for assigning the channel identification to the specific solvent container.

### CROSS-REFERENCE TO RELATED APPLICATIONS

This application is the national stage under 35 U.S.C. 371 of International Application No. PCT/IB2022/057302, filed on Aug. 5, 2022; which claims priority to UK Application No. 2111355.0, filed on Aug. 6, 2021; the entire contents of which are incorporated by reference herein.

### TECHNICAL FIELD

The present invention relates to a solvent supply for chromatographic sample separation.

### BACKGROUND

For liquid separation in a chromatography system, a mobile phase comprising a sample fluid (e.g. a chemical or biological mixture) with compounds to be separated is driven through a stationary phase (such as a chromatographic column packing), thus separating different compounds of the sample fluid which may then be identified. The term compound, as used herein, shall cover compounds which might comprise one or more different components.

The mobile phase, typically comprised of one or more solvents, is pumped under high-pressure typically through a chromatographic column containing packing medium (also referred to as packing material or stationary phase). As the sample is carried through the column by the liquid flow, the different compounds, each one having a different affinity to the packing medium, move through the column at different speeds. Those compounds having greater affinity for the stationary phase move more slowly through the column than those having less affinity, and this speed differential results in the compounds being separated from one another as they pass through the column. The stationary phase is subject to a mechanical force generated in particular by a hydraulic pump that pumps the mobile phase usually from an upstream connection of the column to a downstream connection of the column. As a result of flow, depending on the physical properties of the stationary phase and the mobile phase, a relatively high-pressure drop is generated across the column.

The mobile phase with the separated compounds exits the column and passes through a detector, which registers and/or identifies the molecules, for example by spectrophotometric absorbance measurements. A two-dimensional plot of the detector measurements against elution time or volume, known as a chromatogram, may be made, and from the chromatogram the compounds may be identified. For each compound, the chromatogram displays a separate curve feature also designated as a “peak”.

Mobile phase preparation is a crucial step in the liquid chromatography workflow, but it is error-prone and requires appropriate training e.g. of the lab technicians. It has a huge impact on the quality of the acquired chromatographic data. Moreover, manual mixing steps are difficult to trace, and errors done during preparation will only be visible during the review of the chromatographic results. This shows how important accurate completion and documentation of this step is. Some analytical labs rely on ready-made mobile phases, e.g. purchased from renowned manufacturers. But the diversity and limited shelf-life of mobile phases require a manual preparation for the majority of liquid chromatography applications.

When changing bottles containing solvent to provide the mobile phase, the workflow for an operator typically is to take a solvent bottle off a solvent bottle tray, open a screw cap, pull out a solvent tubing e.g. with an attached solvent filter, put the solvent bottle aside, open the new solvent bottle, put in the solvent tubing with filter, close the bottle with the screw cap, and finally close the previous solvent bottle with a screw cap. For zero failed analysis, it is important to position the right solvent bottle on the right input channel of an LC instrument. Mixing up solvent bottles is a common error.

WO2014015186A1, the entire contents of which are incorporated by reference herein, describes an automated solution dispenser e.g. for filling solvent bottles as specified for example by a user. The bottles can then be provided with a label specifying content of the bottle.

WO2014153081A1, the entire contents of which are incorporated by reference herein, describes usage of prefilled solvent cartridges in HPLC assays. A colour coding can be applied for “reagent boxes”.

JP2013024601A, the entire contents of which are incorporated by reference herein, describes a colour coding of solvent bottles and connection tubings of the pump.

WO2018134750A1, the entire contents of which are incorporated by reference herein, describes a shape and colour coding e.g. of solvent bottles in an HPLC system.

### SUMMARY

It is an object of the present disclosure to provide an improved solvent supply, such as for chromatographic sample separation.

An embodiment relates to a solvent supply system for supplying solvent for one or more chromatographic separation systems. Each chromatographic separation system comprises one or more input channels, wherein each input channel is configured for fluidically coupling with a respective solvent container for supplying the respective input channel with a respective solvent from respective solvent container. The solvent supply system comprises a solvent identification unit configured for providing a channel identification for identifying a specific solvent container to supply a specific input channel of a specific chromatographic separation system, and for assigning the channel identification to the specific solvent container. This allows a marking and/or identification of the solvent container with respect to its destination and/or application, in contrast to most conventional systems wherein solvent containers are typically marked or identified with respect to the content of such container. Accordingly, this can significantly improve handling of such solvent containers and avoid or at least reduce mistakes resulting from erroneously position and/are fluidically coupling a wrong solvent container to a specific input channel of a specific chromatographic separation system. Such improvement can be helpful for users to ensure that the correct solvent container is used to supply a specific input channel. However, e.g. such “destination marking” according to the present disclosure also allows simplifying and improving an automatic handling of such solvent containers in that e.g. a verification (of the correct positioning of a respective solvent container to a respective input channel) does not require additional knowledge of which specific solvent content is required for such input channel, but it may be sufficient to simply verify whether such “destination marking” (of the solvent container) also corresponds with actual destination (of the respective input channel of the respective chromatographic separation system).

In one embodiment, assigning the channel identification to the specific solvent container comprises marking the specific solvent container with the channel identification. This allows providing the solvent container with the channel identification for example in a way that the channel identification can be visualized, e.g. by providing a label, thus allowing e.g. an optical inspection and/or verification of the channel identification.

In one embodiment, assigning the channel identification to the specific solvent container comprises that the channel identification is physically attached or coupled to or with the specific solvent container. This can reduce potential errors by ensuring that the channel identification and the solvent container are physically linked with each other.

In one embodiment, assigning the channel identification to the specific solvent container comprises that the specific solvent container is configured to be modified by the channel identification. For example, the appearance of the solvent container can be modified, for example by modifying the visual and/or physical appearance of the solvent container.

In one embodiment, assigning the channel identification to the specific solvent container comprises that the specific solvent container comprises a storage modified by the channel identification. Such storage may be a near field communication (NFC) device allowing to a contact free communication. However, any other type of communications, including wired or wireless communication, can be applicable as well.

In one embodiment, the channel identification comprises a label identifying the specific input channel and/or the specific chromatographic separation system. Such labelling allows an easy, simple and transparent usage of the channel identification, and can be useful in particular for optical inspection and/or verification.

In one embodiment, the channel identification comprises a marking identifying the specific input channel and/or the specific chromatographic separation system. Such marking allows an easy, simple and transparent usage of the channel identification, and can be useful in particular for optical inspection and/or verification.

In one embodiment, the channel identification comprises a color coding assigning a respective color to the specific input channel and/or the specific chromatographic separation system. For example, a specific color is assigned and relating to a specific input channel of a specific chromatographic separation system, e.g. the color “red” is assigned to a specific input channel ABC of a specific chromatographic separation system XYZ. Such color coding may not only be very intuitive, but also can be useful in particular for optical inspection and/or verification.

In one embodiment, the channel identification comprises a symbol coding assigning a respective symbol to the specific input channel and/or the specific chromatographic separation system. For example, a specific symbol is assigned and relating to a specific input channel of a specific chromatographic separation system, e.g. the symbol “triangle” is assigned to a specific input channel ABC of a specific chromatographic separation system XYZ. Such symbol coding may not only be very intuitive, but also can be useful in particular for optical inspection and/or verification.

In one embodiment, the channel identification comprises a shape coding assigning a respective shape to the specific input channel and/or the specific chromatographic separation system. For example, a specific shape is assigned and relating to a specific input channel of a specific chromatographic separation system, e.g. a “star shape” attached to a respective solvent container is assigned to a specific input channel ABC of a specific chromatographic separation system XYZ. Such shape coding may not only be very intuitive, but also can be useful in particular for optical inspection and/or verification.

In one embodiment, the channel identification comprises a timing information specifying a timeframe in which the specific solvent container can or is to be fluidically coupled with the specific input channel. This can be very useful in case a respective input channel requires different solvents over the time, so that the timing information allows e.g. verifying that the correct solvent container is fluidically coupled to a respective input channel within the correct timeframe when the input channel requires the solvent from such solvent container.

In one embodiment, the channel identification for a respective solvent container is independent of and/or different from an information specifying a content of solvent of the respective container. This allows e.g. using the channel identification (specifying the destination of the solvent container) in combination with other information relating to the content of the solvent container, in particular when it is e.g. legally required to provide certain information about the content (for example identifying a specific solvent or solvent mixture). The channel identification may be added for example to a marking or labelling of the content information, for example by applying a color coding, symbol coding, shape coding, or the like.

In one embodiment, the solvent supply system comprises a data communication system configured to provide the solvent supply system with information which input channel of which chromatographic separation system requires which solvent, or additionally at which time. The solvent identification unit is configured for applying the information from the data communication system for providing the channel identification.

In one embodiment, the data communication system is configured to communicate with one or more of the chromatographic separation systems.

In one embodiment, the data communication system is configured to communicate with a management unit, such as a server, configured for providing a data management of or with one or more of the chromatographic separation systems.

In one embodiment, the solvent supply system comprises a solvent filling unit configured for filling a respective solvent into a respective solvent container.

In one embodiment, the solvent identification unit is configured for providing the channel identification to a respective solvent container in context of filling (such as before, while or after filling) the solvent filling unit filling the respective solvent container.

An embodiment relates to a chromatography system comprising one or more chromatographic separation systems. Each chromatographic separation system comprises a mobile phase drive configured for driving a mobile phase through a separating device for chromatographically separating compounds of a sample fluid in the mobile phase. Each mobile phase drive comprises one or more input channels, each input channel being configured for fluidically coupling with a respective solvent container for supplying the respective input channel with a respective solvent from respective solvent container. The mobile phase drive is configured for mixing and pressurising one or more of the solvents in order to provide the mobile phase. The chromatographic system comprises a solvent supply system, according to any one of the afore-described embodiments, for providing a channel identification for identifying a specific solvent container to supply a specific input channel of a specific chromatographic separation system, for assigning the channel identification to the specific solvent container.

In one embodiment, the chromatography system comprises a verification unit configured for verifying whether a specific channel identification at a specific solvent container matches to a specific input channel of a specific chromatographic separation system.

In one embodiment, the verification unit is configured to verify matching of the specific channel identification with the specific input channel of the specific chromatographic separation system before or when the specific solvent container is fluidically coupled with the specific input channel.

In one embodiment, the verification unit comprises a detection unit, such as an optical detection unit, configured for detecting, such as optically detecting, the channel identification, and a comparison unit for comparing the detected channel identification with a target channel identification, wherein the target channel identification is representative of a target solvent required for supplying the specific input channel of the specific chromatographic separation system.

In one embodiment, the verification unit is configured for initiating a verification signal indicating whether or not the specific channel identification matches to the specific input channel of the specific chromatographic separation system.

In one embodiment, one or more of the input channels each comprises a respective channel ID for identifying the respective input channel, wherein corresponding respective channel identification and channel ID may be similar or identical.

An embodiment relates to a method in a solvent supply system for supplying solvent for one or more chromatographic separation systems. Each chromatographic separation system comprises one or more input channels, wherein each input channel is configured for fluidically coupling with a respective solvent container for supplying the respective input channel with a respective solvent from respective solvent container The method comprises providing a channel identification for identifying a specific solvent container to supply a specific input channel of a specific chromatographic separation system, and assigning the channel identification to the specific solvent container.

In one embodiment, the separation system further comprises at least one of a sample dispatcher configured to introduce the sample fluid into the mobile phase, a detector configured to detect separated compounds of the sample fluid, a collection unit configured to collect separated compounds of the sample fluid, a data processing unit configured to process data received from the fluid separation system, a degassing apparatus for degassing the mobile phase.

In one embodiment, the separation system is a liquid chromatography system, wherein the sample fluid is a sample liquid, the mobile phase is comprised of one or more liquid solvents, and the separating device is a chromatographic column configured for separating liquid compounds of the sample liquid in the mobile phase.

Embodiments of the present disclosure might be embodied based on most conventionally available HPLC systems, such as the Agilent 1220, 1260 and 1290 Infinity II LC Series (provided by the applicant Agilent Technologies).

The separating device may comprise a chromatographic column providing the stationary phase. The column might be a glass, metal, ceramic or a composite material tube (e.g. with a diameter from 50 μm to 5 mm and a length of 1 cm to 1 m) or a microfluidic column (as disclosed e.g. in EP 1577012 A1, the entire contents of which are incorporated by reference herein, or the Agilent 1200 Series HPLC-Chip/MS System provided by the applicant Agilent Technologies). The individual components are retained by the stationary phase differently and separate from each other while they are propagating at different speeds through the column with the eluent. At the end of the column they elute at least partly separated from each other. During the entire chromatography process the eluent might be also collected in a series of fractions. The stationary phase or adsorbent in column chromatography usually is a solid material. The most common stationary phase for column chromatography is silica gel, followed by alumina.

The solvent and/or mobile phase (or eluent) can be either a pure solvent or a mixture of different solvents. It can also contain additives, i.e. be a solution of the said additives in a solvent or a mixture of solvents. It can be chosen e.g. to adjust the retention of the compounds of interest and/or the amount of mobile phase to run the chromatography. The mobile phase can also be chosen so that the different compounds can be separated effectively. The mobile phase might comprise an organic solvent like e.g. methanol or acetonitrile, often diluted with water. For gradient operation water and organic solvent are delivered in separate containers, from which the gradient pump delivers a programmed blend to the system. Other commonly used solvents may be isopropanol, tetrahydrofuran (THF), hexane, ethanol and/or any combination thereof or any combination of these with aforementioned solvents.

The sample fluid might comprise any type of process liquid, natural sample like juice, body fluids like plasma or it may be the result of a reaction like from a fermentation broth.

The fluid may be a liquid but may also be or comprise a gas and/or a supercritical fluid (as e.g. used in supercritical fluid chromatography—SFC—as disclosed e.g. in U.S. Pat. No. 4,982,597 A), the entire contents of which are incorporated by reference herein.

The pressure in the mobile phase might range from 2-200 MPa (20 to 2000 bar), in particular 10-150 MPa (100 to 1500 bar), and more particularly 50-130 MPa (500 to 1300 bar).

The HPLC system might further comprise a detector for detecting separated compounds of the sample fluid, a fractionating unit for outputting separated compounds of the sample fluid, or any combination thereof. Further details of HPLC system are disclosed with respect to the aforementioned Agilent HPLC series, provided by the applicant Agilent Technologies.

Embodiments of the present disclosure may be partly or entirely embodied or supported by one or more suitable software programs or products, which can be stored on or otherwise provided by any kind of non-transitory medium or data carrier, and which might be executed in or by any suitable data processing unit such as an electronic processor-based computing device (or system controller, control unit, etc.) that includes one or more electronic processors and memories. Software programs or routines (e.g., computer-executable or machine-executable instructions or code) may be applied in or by the control unit, e.g. a data processing system such as a computer, such as for executing any of the methods described herein. For example, one embodiment of the present disclosure provides a non-transitory computer-readable medium that includes instructions stored thereon, such that when executed on a processor, the instructions perform the steps of the method of any of the embodiments disclosed herein.

### BRIEF DESCRIPTION OF DRAWINGS

Other objects and many of the attendant advantages of embodiments of the present disclosure will be readily appreciated and become better understood by reference to the following more detailed description of embodiments in connection with the accompanying drawings. Features that are substantially or functionally equal or similar will be referred to by the same reference signs.

FIG. 1 illustrates a liquid chromatography system according to an exemplary embodiment.

FIG. 2 schematically illustrates a chromatographic system according to an exemplary embodiment.

FIG. 3A illustrates a software interface of a solvent a solvent filling unit and a labeled solvent container according to an exemplary embodiment.

FIG. 3B illustrates labeled solvent containers according to an exemplary embodiment.

FIG. 3C illustrates a solvent label according to an exemplary embodiment.

FIG. 4 illustrates a solvent mixture label according to an exemplary embodiment.

### DETAILED DESCRIPTION

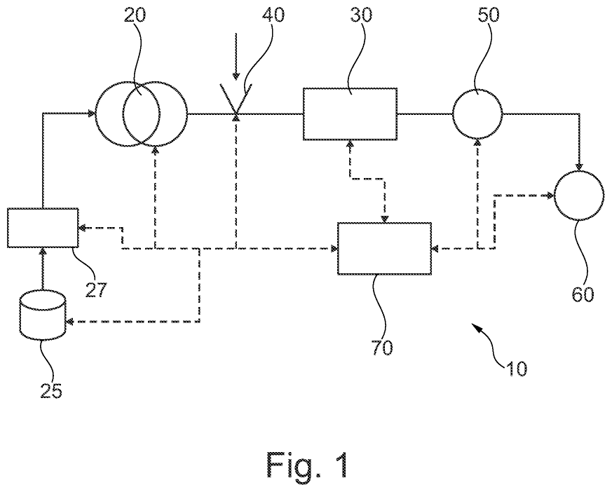

Referring now in greater detail to the drawings, FIG. 1 depicts a general schematic of a liquid separation system 10. A mobile phase drive 20 (such as a pump) receives a mobile phase from a solvent supply 25, typically via a degasser 27, which degases the mobile phase and thus reduces the amount of dissolved gases in it. The mobile phase drive 20 drives the mobile phase through a separating device 30 (such as a chromatographic column). A sample injector 40 (also referred to as sample introduction apparatus, sample dispatcher, etc.) is provided between the mobile phase drive 20 and the separating device 30 in order to subject or add (often referred to as sample introduction) portions of one or more sample fluids into the flow of a mobile phase. The separating device 30 is adapted for separating compounds of the sample fluid, e.g. a liquid. A detector 50 is provided for detecting separated compounds of the sample fluid. A fractionating unit 60 can be provided for outputting separated compounds of sample fluid. In one embodiment, at least parts of the sample injector 40 and the fractionating unit 60 can be combined, e.g. in the sense that some common hardware is used as applied by both of the sample injector 40 and the fractionating unit 60.

The separating device 30 may comprise a stationary phase configured for separating compounds of the sample fluid. Alternatively, the separating device 30 may be based on a different separation principle (e.g. field flow fractionation).

While the mobile phase can be comprised of one solvent only, it may also be mixed of plurality of solvents. Such mixing might be a low pressure mixing and provided upstream of the mobile phase drive 20, so that the mobile phase drive 20 already receives and pumps the mixed solvents as the mobile phase. Alternatively, the mobile phase drive 20 might be comprised of plural individual pumping units, with plural of the pumping units each receiving and pumping a different solvent or mixture, so that the mixing of the mobile phase (as received by the separating device 30) occurs at high pressure and downstream of the mobile phase drive 20 (or as part thereof). The composition (mixture) of the mobile phase may be kept constant over time, the so-called isocratic mode, or varied over time, the so-called gradient mode.

A data processing unit 70, which can be a conventional PC or workstation, might be coupled (as indicated by the dotted arrows) to one or more of the devices in the liquid separation system 10 in order to receive information and/or control operation.

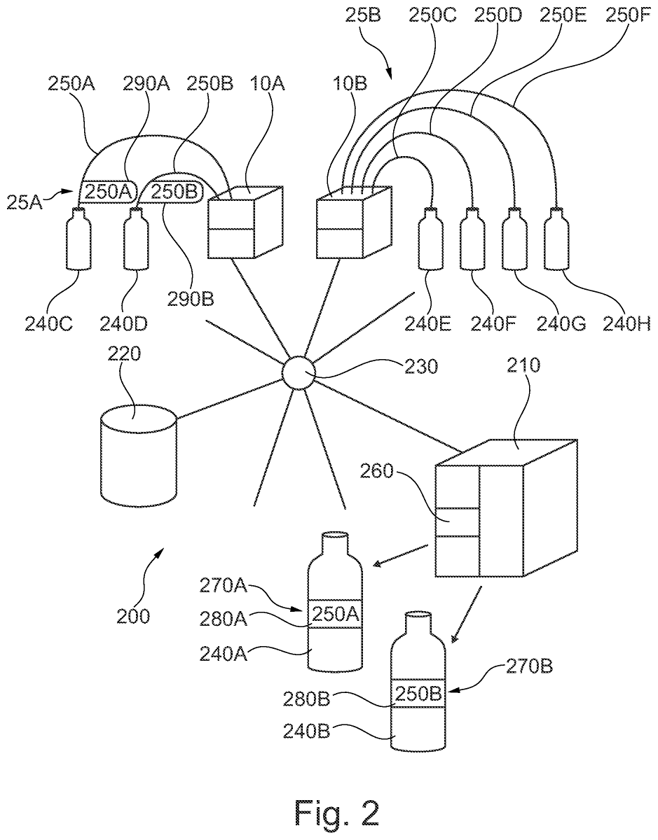

FIG. 2 schematically illustrates a chromatographic system 200 comprising one or more liquid separation systems 10A, 10B, etc., a solvent filling unit 210, and a (central) server 220. In the exemplary embodiment of FIG. 2, two liquid separation systems 10A and 10B are shown, which may be the same or similar to the liquid separation system 10 schematically shown in FIG. 1, however, it is clear that that also only one liquid separation system 10 or more than two liquid separation systems 10 can be applied accordingly.

Each of the liquid separation systems 10, the solvent filling unit 210, and the server 220 are coupled together by a network 230, which may be any data communication network (wired and/or wireless) allowing the coupled devices to communicate which each other in order to send and/or receive data. This is readily clear in the art and does not need to be further illustrated and explained here.

The solvent filling unit 210 may be any kind of system unit allowing to fill one or more respective solvent containers each with one or more solvents, so that the respective solvent container then contains either a pure solvent (e.g. water H2O, acetonitrile, et cetera) or a mixture thereof for example according to a given mixing ratio. This is schematically indicated by the arrows in FIG. 2 representing that the output of the solvent filling unit 210 in the example shown in FIG. 2 is two solvent containers 240A and 240B. It goes without saying that this is not limited to two solvent containers. Accordingly, in the example here, the solvent filling unit 210 provides the two solvent containers 240A and 240B each with a specified content such as a pure solvent or a solvent mixture. It is also clear that the size and/or shape of the solvent containers 240 may either be the same or different.

The solvent filling unit 210 can be any kind of filling station as known in the art, e.g. the automated solution dispenser as disclosed in the aforementioned WO2014015186A1. The solvent filling unit 210 may comprise one or more solvent tanks (not shown in FIG. 2), typically with a volume significantly larger than the solvent containers 240.

As illustrated with respect to FIG. 1, each liquid separation system 10 has a respective solvent supply 25 for providing the respective mobile phase. In the exemplary embodiment of FIG. 2, the liquid separation system 10A is supplied with two solvent containers 240C and 240D representing the solvent supply 25A of the liquid separation system 10A. Accordingly, the liquid separation system 10B is supplied with four solvent containers 240E-240H representing the solvent supply 25B of the liquid separation system 10B.

Each solvent supply 25 comprises one or more input channels 250 for fluidically coupling with a respective solvent container 240. In the exemplary embodiment of FIG. 2, the solvent supply 25A has two input channels 250A and 250B, and the solvent supply 25B shall have four input channels 250C-250F. Accordingly, solvent container 240C is fluidically coupled with input channel 250A, solvent container 240D is fluidically coupled with input channel 250B, solvent container 240E is fluidically coupled with input channel 250C, solvent container 240F is fluidically coupled with input channel 250D, solvent container 240G is fluidically coupled with input channel 250E, and solvent container 240H is fluidically coupled with input channel 250F.

It is clear that the number of liquid separation systems 10, solvent filling units 210, servers 220, networks 230, and solvent containers 240 in the embodiment of FIG. 2 is just for the sake of representation and better understanding but not limited in any way. Accordingly, the number and assignment of solvent containers 240 and input channels 250 as depicted in FIG. 2 is also only for the sake of representation and better understanding.

In particular for so-called “zero failed analysis”, it is important to position the correct solvent container 240 at the correct input channel 250 of the correct liquid separation system 10, in order to supply such input channel 250 with the required solvent. It has been found that mixing up solvent containers 240 and input channels 250 is a common error.

In order to avoid mixing up solvent containers 240 and input channels 250, the solvent filling unit 210 has a solvent identification unit 260 (schematically indicated in FIG. 2) providing a respective channel identification 270. Each channel identification 270 identifies a specific solvent container 240 to supply a specific input channel 250 of a liquid separation system 10. In other words, each channel identification 270 identifies the destination a specific solvent container 240 where to supply a specific input channel 250 of a liquid separation system 10.

In the example of FIG. 2, the solvent container 240A is filled up with a solvent (mixture) to supply the solvent channel 250A. For the sake of simplicity, the channel identification 270A shall be “250A”, specifying that the solvent container 240A shall supply and is to be fluidically coupled to the solvent channel 250A. Accordingly, the solvent container 240A bears a label 280A showing the channel identification 270A, namely “250A”. Further in the example of FIG. 2, the solvent container 240B is filled up with a solvent (mixture) to supply the solvent channel 250B. For the sake of simplicity, the channel identification 270B shall be “250B”, specifying that the solvent container 240B shall supply and is to be fluidically coupled to the solvent channel 250B. Accordingly, the solvent container 240B bears a label 280B showing the channel identification 270B, namely “250B”.

The solvent filling unit 210 may provide each of the solvent containers 240 directly bearing the respective label 280, for example in the sense that the solvent filling unit 210 is fully automated and providing as output the solvent containers 240 each with a respective label 280 (showing the respective channel identification 270). However, it is clear that the marking of the respective solvent container 240 with the respective label 280 may also be a separate step or process and may be done automatically or even manually. For example, the solvent filling unit 210 may provide as output the respective labels 280 which may then be stuck to the respective solvent container 240. It goes without saying that an automated process providing the solvent container 240 directly with the respective label 280 helps avoiding mixing up of different labels 280.

The solvent container 240A now bears the (visual) channel identification 270A, namely the label 280 “250A”. In the example here, solvent container 240A is to replace solvent container 240C currently (as shown in FIG. 2) fluidically coupled to the input channel 250A. The solvent container 240A may then be (physically) transported and fluidically coupled to the input channel 250A in order to supply the liquid separation system 10A with the solvent contained therein. In the same way, the solvent container 240B bears the (visual) channel identification 270B, namely the label 280 “250B”, and is to replace solvent container 240D currently (as shown in FIG. 2) fluidically coupled to the input channel 250B. The solvent container 240B may then be (physically) transported and fluidically coupled to the input channel 250B in order to supply the liquid separation system 10A with the solvent contained therein.

From the above description it becomes apparent that the respective channel identification 270 does not describe the content of the respective solvent container 240 but its destination or “place of application”, namely to which respective input channel 250 the respective solvent container 240 is to be fluidically coupled to.

Such channel identification 270 may be provided and used instead of or in addition to the traditional “content labelling” identifying the content of the respective solvent container 240. In an example, the solvent container 240 may only bear the channel identification 270 but no other marking or labelling. In another example, the solvent container 240 may bear the channel identification 270 as well as additional marking or labelling e.g. specifying the content of the solvent bottle as well as other information typically provided with solvents.

In the exemplary embodiment of FIG. 2, the channel identification 270 has been represented by the label 280 and bearing the name or identification number of the respective input channel 250. However, it is clear that the channel identification 270 may also apply-alternatively or in addition-any kind of coding such as color coding, symbol coding, shape coding, et cetera, cither alone or in combination. As an example and indicated in FIG. 2, the input channel 250A may be represented by the color “yellow”, and accordingly the channel identification 270A would then also be represented by the color “yellow”, for example a yellow label (in combination with or instead of the label “250A” in FIG. 2). Further in this example, the input channel 250B may be represented by the color “red”, and accordingly the channel identification 270B would then also be represented by the color “red”, for example a red label (in combination with or instead of the label “250B” in FIG. 2). Alternatively or in addition, shape coding may be applied accordingly.

Instead of (physically) marking the respective solvent container 240 e.g. by providing or sticking on the label 280, the solvent identification unit 260 may also make use of specific properties of the respective solvent containers 240. For example, the solvent container 240 may have an electronic label (such as a display or the like), so that the solvent identification unit 260 may modify such electronic label in order to show the respective channel identification 270. In such embodiment, the solvent identification unit 260 and/or the solvent filling unit 210 may not need to physically attach or otherwise couple the channel identification 270 to the respective solvent container 240.

Providing the channel identification 270 in a visual way to the solvent container 240 may be beneficial in particular in case the transport of the solvent containers 240 to the respective input channels 250 is done manually e.g. by a user. In case of an automated system not requiring any user interaction in particular for the transport of the solvent container 240, the channel identification 270 may also be provided in a non-visual way, for example applying electronic tagging or other kind of labels, such as RFID tags.

In case a respective input channel 250 may require different solvents at different times, the channel identification 270 may further comprise a timing information specifying a timeframe in which the specific solvent container 240 can or is to be fluidically coupled with the specific input channel 250.

In the embodiment of FIG. 2, the solvent filling unit 210 receives via the network 230 information about which respective solvent is required for which respective input channel 250. As an example, the solvent filling unit 210 may receive directly from the liquid separation system 10A information about which of its input channels 250A and 250B requires which solvent at which time. Alternatively or in addition, such information may also be provided by the server 220 which may be a central resource for coordinating and managing operation of the respective liquid separation systems 10.

The solvent identification unit 260 may also receive information about which input channel 250 requires which solvent at which time, for example from the solvent filling unit 210 or via the network 230 e.g. from the respective liquid separation system 10 and/or the server 220. Based on such information, the solvent identification unit 260 may then provide the respective channel identification 270.

In an embodiment, each liquid separation system 10 may comprise a verification unit configured for verifying whether a specific channel identification 270 at a specific solvent container 240 matches to a specific input channel 250 of a specific liquid separation system 10. Such verification unit may be configured to verify matching of the specific channel identification 270 with the specific input channel 250 of the specific liquid separation system 10, for example before or when the specific solvent container 240 is fluidically coupled with the specific input channel 250. Such verification unit may comprise a (dedicated) detection unit, for example an optical detection unit (e.g. a scanner or a camera), configured for detecting, for example optically detecting, the channel identification 270. In an example, where the channel identification 270 is the label 280, e.g. as exemplarily shown in FIG. 2, and where the detection unit comprises a camera, the camera may scan the solvent container 240 and the detection unit may apply any kind of image recognition in order to detect the label 280.

Such verification unit may further comprise a comparison unit for comparing the detected channel identification 270 with a target channel identification, wherein the target channel identification is representative of a target solvent required for supplying the specific input channel 250 of the liquid separation system 10. Further in the above given example, the detection unit may apply an image recognition and may detect, for example, “250B” as the label 280B of the solvent container 240B. As the solvent container 240B is meant to supply the input channel 250B, the target channel identification is “250B” for the solvent container 240B. The comparison unit then compares the detected “250B” with the target channel identification “250B” and will find this matching. The objects designated 10A and 10B in FIG. 2 are considered as schematically depicting the verification unit, detection unit, and comparison unit as part of the respective liquid separation systems 10A and 10B.

Such verification unit may further be configured for initiating a verification signal indicating whether or not the detected channel identification 270 matches to the specific input channel 250 of the liquid separation system 10. Further in the above example, as the comparison unit finds a match between the detected “250B” with the target channel identification “250B”, it may issue a signal indicating such match (for example flashing a green light). In case the comparison unit finds that the detected channel identification 270 does not match with the specific input channel 250 of the liquid separation system 10, the comparison unit may provide a corresponding signal (for example flashing a red light) and/or may disable operation of the respective solvent supply 25, so that the respective input channel 250 of the respective liquid separation system 10 is or will not be supplied with solvent from the non-matching solvent container 240.

In order to further improve clear assignment of a dedicated solvent container 240 to a dedicated input channel 250, the input channel 250 may be provided (in particular visualized) with a channel ID 290 for identifying the respective input channel 250. In the above example, the input channel 250A bears “250A” as the channel ID 290A, and the input channel 250B bears “250B” as the channel ID 290B, for example as a flag, label, et cetera. For the sake of simplicity and also for increasing intuitiveness, corresponding channel identifications 270 and channel IDs 290 may be embodied to be identical or at least highly similar, as in the example here where both of the channel ID 290B and the channel identification 270B bear the identical label or marking “250B”. Intuitiveness may further be improved by applying the same or at least highly similar color coding for the channel ID 290 and the channel identification 270. In the exemplary embodiment of FIG. 2, this is indicated by showing the channel ID 290A with the color “yellow” and the channel ID 290B with the color “red”.

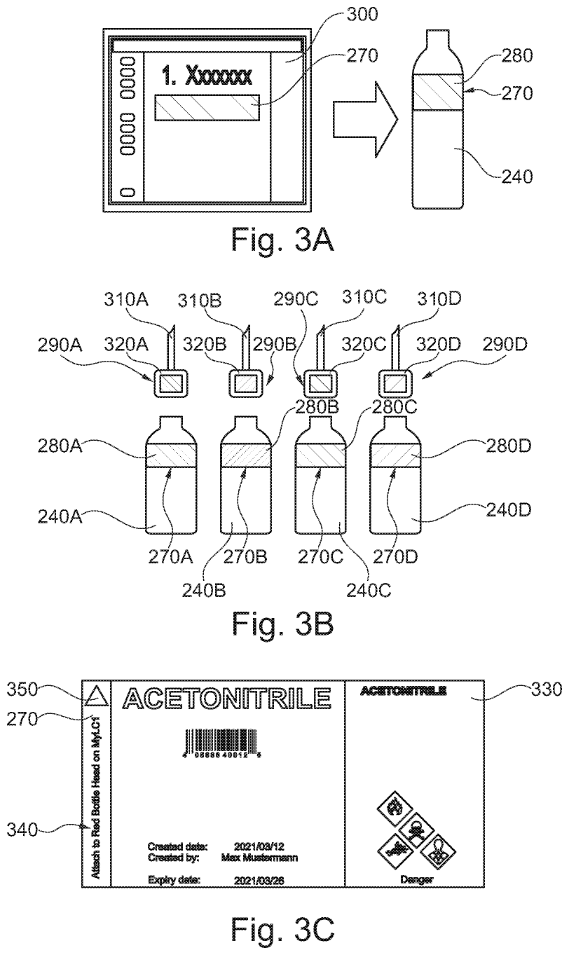

A further embodiment shall be illustrated in the following with respect to FIG. 3. In this embodiment, colored bands or colored stickers are applied as labels 280 and can be attached as channel identification 270 to any common size solvent container 240 (which shall also be referred to in the following as solvent bottles 240). A corresponding software, e.g. run on the solvent filling unit 210 and/or the server 220, may guide a user through several steps of solvent mixing and providing the channel identification 270. Such steps may involve the following workflow:

A software is used to plan analysis workflow e.g. in laboratories. Part of this is to plan the consumables used and the instrument method (including the solvent specification for each instrument solvent channel, i.e. for each input channel 250). To avoid mixing up the solvent bottles 240, a system comprising of identifiers, a software system including a database and identifiable solvent channels on the LC 10 is applied.

As schematically indicated in FIG. 3A, information 300 on the specifics of the solvents, in particular a mixing ratio, is provided (e.g. from the respective liquid separation system 10 and/or the server 220) to the solvent filling unit 210. The software interface of the solvent filling unit 210 guides the user through the solvent mixing steps.

In the example here in FIG. 3A, an empty solvent bottle 240 is filled with a pure HPLC grade solvent or a mixture of two or more solvents as described by the software.

The software tells e.g. the user what channel identification 270, e.g. a color band/sticker 280, is to be attached to the solvent bottle 250 according to the input channel 250 defined by the instrument method. The solvent filling unit 210 may know the pump configuration and define hereby the respective bottle location. The color coding of the channel identification 270 may not only be applied to the label/sticker 280, but also be provided e.g. with a cap of the solvent bottle 250, and ink label, et cetera.

In the example of FIG. 3A, the information 300 indicates as channel identification 270 the color “blue”, and accordingly a respective label 280 bearing the color “blue” can be affixed on the solvent bottle 240.

Having multiple identifiers (i.e. channel identification 270) unified in one physical object and a central data storage holding the solvent information linked with all that identifiers allows to use the best fitting technology for each dedicated situation.

FIG. 3B shows four different solvent bottles 240A-240D each bearing a different channel identification 270A using a color coding. In the example here, solvent bottle 240A bears a label 280A showing the color “blue” as the channel identification 270, solvent bottle 240B bears a label 280B showing the color “yellow” as the channel identification 270B, solvent bottle 240C bears a label 280C showing the color “red” as the channel identification 270C, and solvent bottle 240D bears a label 280D showing the color “green” as the channel identification 270D.

FIG. 3B further shows parts of four different input channels 250A-250D, namely such part of the respective input channel 250 configured for providing the fluidic coupling to the respective solvent bottle 240. In the exemplary embodiment here, such coupling part of the input channel 250 is configured as a respective tubing 310 (for fluidically conducting the respective solvent) with a respective cap 320 configured for being mounted with the respective solvent bottle 240. It is clear that this is only a schematic representation here and any kind of fluidic coupling between solvent bottle 240 and input channel 250 may be applied here. Also, the fluidic coupling at a top side of the solvent bottle 240 is just an example, but the solvent bottle 240 may also be positioned upside down with the bottle opening facing downwards.

In the embodiment shown in FIG. 3B, the respective cap 320 can be mounted (e.g. screwed) on the respective solvent bottle 240 for providing the fluidic coupling between the respective solvent bottle 240 and the respective input channel 250, so that solvent from within the solvent bottle 240 can be transferred via the tubing 310 the liquid separation system 10.

In FIG. 3B, the input channel 250A comprises tubing 310A and cap 320A, the input channel 250B comprises tubing 310B and cap 320B, the input channel 250C comprises tubing 310C and cap 320C, and the input channel 250D comprises tubing 310D and cap 320D. Further, cap 320A shall bear a blue marking as channel ID 290A, cap 320B shall bear a yellow marking as channel ID 290B, cap 320C shall bear a red marking as channel ID 290C, and cap 320D shall bear a green marking as channel ID 290D.

As indicated in FIG. 3B, when bringing the solvent bottles 240 to the LC 10, the user should match the channel identification 270 (here, the color of the band/sticker 280) of the solvent bottle 240 with the channel ID 290 (here, the color of the solvent cap 320) in the LC 10 to ensure the correct allocation of solvent to the instrument solvent channel 250. This is indicated in FIG. 3B with the correct solvent bottle 240 being allocated at the correct cap 320 of the respective input channel 250. The color coding is intuitive and allows preventing errors resulting from a wrong allocation of solvent bottle 240 to input channel 250.

Not shown in FIG. 3, a tag reader may be provided, e.g. at the respective liquid separation system 10) for detecting/reading the channel identification 270 and verifying the correct allocation solvent bottle 240 to input channel 250.

FIG. 3C shows an embodiment, wherein the channel identification 270 is part of and/or integrated in a sticker 330. The sticker 330 can for example be a regular solvent label bearing specific information about the content of the respective solvent bottle 240, in particular specific information about the contained solvent or solvent mixture, as may be legally required. The sticker 330 in the example of FIG. 3C shows specific information about the solvent acetonitrile.

As indicated in FIG. 3C, the channel identification 270 as provided on the sticker 330 may provide specific destination information 340 and/or a specific symbol 350 corresponding to such channel identification 270.

For further solvent tagging and tracking, the solvent bottle 240 may have additional electronic storage functionality, such as a near field communication (NFC) tag, which can be modified (e.g. written) by the solvent filling unit 210 and read at the liquid separation system 10. Automated warning and error message can be provided in case a wrong solvent bottle 240 is attached on a respective input channel 250.

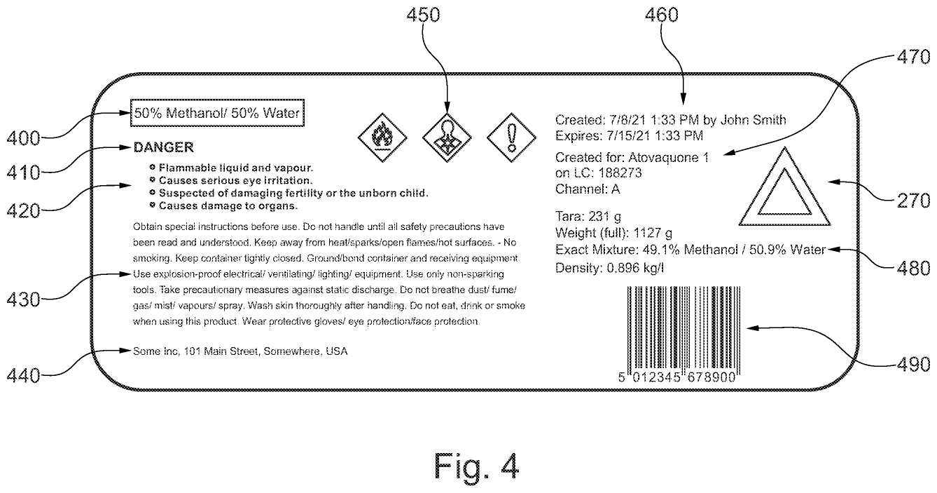

A further embodiment shall be illustrated with respect to FIG. 4. For popular solvent mixtures there are predesigned and/or preprinted labels which cannot be modified. For less common mixtures or in smaller labs, labels must be created manually. This is error prone and takes time. Also, the correct labeling for a mixture may not be obvious and require looking up Safety Data Sheets (SDS) or even having to be deduced by the technician based on his chemical knowledge if no SDS is available, inducing effort and error sources. Both solutions do not include application information or a digital tag for dynamic data and automatic reading of the label. Additionally, neither solution adds the data to a database.

Based on information about a mixture's contents a customizable solvent mixture label can be automatically created based on predefined rules. It may contain the necessary GHS information and additional application information. Also, an NFC tag can be added that contains the information for automatic reading as well as additional dynamic data. Upon label creation, the solvent information can also get added to a database. The entry can be retrieved using a barcode/QR code on the label or by scanning the NFC tag. Therefore, the barcode/NFC tag serve as the connection between physical and digital world.

This embodiment can allow correct labeling even of uncommon mixtures removing sources of hazards. Each user/lab manager can customize the labels used in the laboratory to ensure overall safety. It removes the need for manual labeling where the correct labels must be looked up or induced. Errors due to incorrect use of the created solvent in applications is reduced by adding application information to the label. Recording solvent information in a database removes the need of physical interaction to query solvent information. Standardized labels can especially help compliance customers and in general audit trails and environment, health and safety (EHS) compliance.

The embodiment provides advantages in ensuring the correctness of the labeling of hazardous substances by preventing lab technicians from having to look up labels or even deduce them themselves. Also, sources of error of a manual labeling process are removed. It increases the efficiency by removing manual work in the labeling process. Additionally, the addition of the solvent information to databases allows for remote and joint query of solvent mixture data. Adding tagging with a barcode and an NFC tag allows automatic retrieval of solvent information which in turn can be automatically processed at other locations e.g. an HPLC instrument. This again can increase efficiency and prevents errors by removing manual interaction. It may encourage the correct use of the solvent mixture in applications by providing additional application information (e.g. instrument, channel connection, position).

The NFC tag can allow adding dynamic data e.g. number of uses to the tag. The ability to customize the label may provide the user with the flexibility to adapt the label's contents to specific needs. By filling the predefined structure dynamically with the right data, the labels can have a unified structure independent of content and labeling user. Using printed labels instead of marker-written labels can increase the resistance of the text to spilled solvent that could make the text unrecognizable. All label and solvent information can be automatically updated in the LC system and will be matched when the user scans the label.

The embodiment consists of two subsystems: The labeling subsystem which creates the label and the tagging & tracking subsystem which allows retrieving the solvent information using the barcode and/or NFC tag.

Labeling subsystem: To create the mixture label information about its components and the used amounts is required. The information about solvents and their required hazard labeling is collected and stored in a database in advance. Additionally, rules for the induction of the hazard labels of mixtures based on the used amounts is stored. The information about the mixture can be taken from one or multiple of: Automatically recorded in a solvent filling station; taken from user authentication; entered by the user manually; taken from the solvent mixture recipe.

Then a label can be created. The label shown in FIG. 4 is an example for a possible solvent mixture label. The contents of the label and their layout are not limited by the given example but are customizable via a graphical editor.

Solvent Identifier 400: GHS required, derived from the used amounts, tolerant to small derivations defined in the mixture rules.

Signal Word 410: GHS required, derived from the safety information from the mixture contents and their amounts.

Hazard Statement 420: GHS required, derived from the safety information from the mixture contents and their amounts.

Precautionary Statement 430: GHS required, derived from the safety information from the mixture contents and their amounts.

Supplier Identification 440: GHS required, derived from the solvent mixture station location.

Pictograms 450: GHS required, derived from the safety information from the mixture contents and their amounts.

Creation date 460: allows tracing the solvents creation for audit and uncovering possible errors, automatically recorded upon label creation.

Expiration date 460: prevents use of expired solvents resulting in errors, created based on creation date and information about used contents.

Author 460: allows tracing for audit and helps discovering errors, entered by the user or recorded by an automatic filling station.

Application Information 470: prevents misuse of the solvent, helps resolving errors, entered by the user.

Channel identification 270 (e.g. LC Channel Symbol): graphical indication that is matched with the corresponding LC channel 250, provides intuitive guidance preventing wrong LC configurations resulting in errors and/or device damage.

Additional Information 480: Tara (tare), weight, exact Mixture and Density are measured during solvent mixing and provide additional data for analysis and auditing. Can be used to analyse derivations of results and their sources.

Barcode 490: Unique identifier of the bottle in the database, used to identify the bottle digitally and retrieve its information.

The label can be printed and attached using various methods, such as: regular digital printing of the label and attaching it via a glued clear cover; label printing via a label printer and attaching it directly; playing the label content to an E-Ink Label and attaching the E-Ink label, et cetera.

Additionally, an NFC tag can be attached to the bottle 240 with a cord or is integrated in the label sticker. The tag can be written with a commercial NFC writer.

The tagging and tracking subsystem may require a database that is accessible from different locations in the lab via a lab network.

Upon label creation an entry for the solvent mixture can be added to the database containing all the information on the label, as well as two unique IDs for both the barcode on the label and the NFC tag.

To retrieve the information, different locations in the lab can be equipped with barcode scanners and/or NFC tag readers. Using the barcode reader, the unique ID of the solvent mixture can be received. The ID can then be used to query the database over the lab network for the solvent information. A lab bus can be used to enable transparent use of multiple databases and/or notify other members of the bus about the scanned information. The same can be done with the NFC tag but also the information can be directly received from the tag and compared with the database information.

It will be understood that one or more of the processes, sub-processes, and process steps described herein may be performed by hardware, firmware, software, or a combination of two or more of the foregoing, on one or more electronic or digitally-controlled devices. The software may reside in a software memory (not shown) in a suitable electronic processing component or system such as, for example, the system controller 70 schematically depicted in FIG. 1 and/or the solvent filling unit 210 and/or server 220 schematically depicted in FIG. 2. The software memory may include an ordered listing of executable instructions for implementing logical functions (that is, “logic” that may be implemented in digital form such as digital circuitry or source code, or in analog form such as an analog source such as an analog electrical, sound, or video signal). The instructions may be executed within a processing module, which includes, for example, one or more microprocessors, general purpose processors, combinations of processors, digital signal processors (DSPs), application specific integrated circuits (ASICs), field-programmable gate array (FPGAs), etc. Further, the schematic diagrams describe a logical division of functions having physical (hardware and/or software) implementations that are not limited by architecture or the physical layout of the functions. The examples of systems described herein may be implemented in a variety of configurations and operate as hardware/software components in a single hardware/software unit, or in separate hardware/software units.

The executable instructions may be implemented as a computer program product having instructions stored therein which, when executed by a processing module of an electronic system (e.g., the system controller 70 schematically depicted in FIG. 1 and/or the solvent filling unit 210 and/or server 220 schematically depicted in FIG. 2), direct the electronic system to carry out the instructions. The computer program product may be selectively embodied in any non-transitory computer-readable storage medium for use by or in connection with an instruction execution system, apparatus, or device, such as an electronic computer-based system, processor-containing system, or other system that may selectively fetch the instructions from the instruction execution system, apparatus, or device and execute the instructions. In the context of this disclosure, a computer-readable storage medium is any non-transitory means that may store the program for use by or in connection with the instruction execution system, apparatus, or device. The non-transitory computer-readable storage medium may selectively be, for example, an electronic, magnetic, optical, electromagnetic, infrared, or semiconductor system, apparatus, or device. A non-exhaustive list of more specific examples of non-transitory computer readable media include: an electrical connection having one or more wires (electronic); a portable computer diskette (magnetic); a random access memory (electronic); a read-only memory (electronic); an erasable programmable read only memory such as, for example, flash memory (electronic); a compact disc memory such as, for example, CD-ROM, CD-R, CD-RW (optical); and digital versatile disc memory, i.e., DVD (optical). Note that the non-transitory computer-readable storage medium may even be paper or another suitable medium upon which the program is printed, as the program may be electronically captured via, for instance, optical scanning of the paper or other medium, then compiled, interpreted, or otherwise processed in a suitable manner if necessary, and then stored in a computer memory or machine memory.

1. A solvent supply system for supplying solvent for one or more chromatographic separation systems each comprising one or more input channels, wherein each input channel is configured for fluidically coupling with a respective solvent container for supplying the respective input channel with a respective solvent from the respective solvent container, the solvent supply system comprising:
a solvent identification unit configured to provide a channel identification for identifying a specific solvent container to supply a specific input channel of a specific chromatographic separation system, and to assign the channel identification to the specific solvent container.

2. The solvent supply system according to claim 1, wherein
assigning the channel identification to the specific solvent container comprises marking the specific solvent container with the channel identification.

3. The solvent supply system according to claim 1, wherein assigning the channel identification to the specific solvent container comprises at least one of the following:
the channel identification is physically attached or coupled to or with the specific solvent container;
the specific solvent container is configured to be modified by the channel identification;
an appearance of the specific solvent container is configured to be modified by the channel identification;
the specific solvent container comprises a storage modified by the channel identification.

4. The solvent supply system according to claim 1, comprising at least one of the following:
the channel identification comprises a label identifying the specific input channel and/or the specific chromatographic separation system;
the channel identification comprises a marking identifying the specific input channel and/or the specific chromatographic separation system;
the channel identification comprises a color coding assigning a respective color to the specific input channel and/or the specific chromatographic separation system;
the channel identification comprises a symbol coding assigning a respective symbol to the specific input channel and/or the specific chromatographic separation system;
the channel identification comprises a shape coding assigning a respective shape to the specific input channel and/or the specific chromatographic separation system.

5. The solvent supply system according to claim 1, wherein:
the channel identification comprises a timing information specifying a timeframe in which the specific solvent container can or is to be fluidically coupled with the specific input channel.

6. The solvent supply system according to claim 1, wherein:
the channel identification for a respective solvent container is independent of and/or different from an information specifying a content of solvent of the respective container.

7. The solvent supply system according to claim 1, comprising:
a data communication system configured to provide the solvent supply system with information about which input channel of which chromatographic separation system requires which solvent,
wherein the solvent identification unit is configured to apply the information from the data communication system for providing the channel identification.

8. The solvent supply system according to claim 7, comprising at least one of the following features:
the data communication system is configured to communicate with one or more of the chromatographic separation systems;
the data communication system is configured to communicate with a management unit configured to provide a data management of or with one or more of the chromatographic separation systems.

9. The solvent supply system according to claim 1, comprising:
a solvent filling unit configured to fill a respective solvent into a respective solvent container.

10. The solvent supply system according to claim 9, wherein:
the solvent identification unit is configured to provide the channel identification to a respective solvent container in context of the solvent filling unit filling the respective solvent container.

11. A chromatography system, comprising:
one or more chromatographic separation systems, each chromatographic separation system comprising a mobile phase drive configured for driving a mobile phase through a separating device for chromatographically separating compounds of a sample fluid in the mobile phase,
wherein each mobile phase drive comprises one or more input channels, each input channel being configured for fluidically coupling with a respective solvent container for supplying the respective input channel with a respective solvent from the respective solvent container, wherein the mobile phase drive is configured for mixing and pressurising one or more of the solvents in order to provide the mobile phase; and
the solvent supply system according to claim 1.

12. The chromatography system according to the preceding claim 11, comprising:
a verification unit configured to verify whether a specific channel identification at a specific solvent container matches to a specific input channel of a specific chromatographic separation system.

13. The chromatography system according to claim 12, comprising at least one of the following features:
the verification unit is configured to verify matching of the specific channel identification with the specific input channel of the specific chromatographic separation systems before or when the specific solvent container is fluidically coupled with the specific input channel;
the verification unit comprises a detection unit configured to detect the channel identification, and a comparison unit for comparing configured to compare the detected channel identification with a target channel identification, wherein the target channel identification is representative of a target solvent required for supplying the specific input channel of the specific chromatographic separation system;
the verification unit is configured to initiate a verification signal indicating whether or not the specific channel identification matches to the specific input channel of the specific chromatographic separation system.

14. The chromatography system according to claim 11, comprising at least one of:
one or more of the input channels each comprises a respective channel ID for identifying the respective input channel;
one or more of the input channels each comprises a respective channel ID for identifying the respective input channel, wherein each channel identification and corresponding channel ID are similar or identical.

15. A method in a solvent supply system for supplying solvent for one or more chromatographic separation systems each comprising one or more input channels, wherein each input channel is configured for fluidically coupling with a respective solvent container for supplying the respective input channel with a respective solvent from the respective solvent container, the method comprising:
providing a channel identification for identifying a specific solvent container to supply a specific input channel of a specific chromatographic separation system; and
assigning the channel identification to the specific solvent container.
